(19) United States
(12) Patent Application Publication
(10) Pub. No.: US 2004/0261590 A1
(43) Pub. Date: Dec. 30, 2004

(54) Gang saw box elevation adjuster

(76) Inventor: Patrick M. Conry, Hot Springs, AR (US)

Correspondence Address: MANELLI DENISON & SELTER, 2000 M STREET NW SUITE 700, WASHINGTON, DC, 20036-3307, US

(21) Appl. No.: 10/825,208

(22) Filed: Apr. 16, 2004

Related U.S. Application Data
(60) Provisional application No. 60/464,091, filed on Apr. 21, 2003.

(51) Int. Cl. B26D 3/00; B27B 1/00

(52) U.S. Cl. 83/51; 83/368; 144/357

(57) ABSTRACT

An apparatus and method of adjusting the vertical position of a cant sawbox relative to a cant feed axis includes a pair of pivotable arms mounted on a base that is slidable along a horizontal axis with each arm pivotably connected to a lower portion of the sawbox; a device upstream of the sawbox detects the thickness and calculates the mid point of the incoming cant and then effects movement of the sawbox so that the midline of the cant coincides with the feed axis.

### FIELD OF THE INVENTION

The present invention relates to an improvement in high-speed gang saw cutting machines and more specifically, to a gang saw box elevation adjuster that will improve the efficiency and cutting accuracy of the machinery.

### BACKGROUND OF THE INVENTION

In present-day woodcutting mills, various advancements have been made in the machinery design and operation to increase the throughput efficiency and accuracy of the woodcutting operation. One such significant improvement will be found in U.S. Pat. No. 5,722,474, granted in Mar. 3, 1998, in which the saw box is mounted to be pivotable by a computer-controller relative to the throughput path of a wood cant moving on a transfer belt or conveyor, the speed of which is also computer-controlled. While the object of the invention described in the aforementioned patent was readily achieved, namely, by producing more salable product from even a previously low valued curved cant, there is additional value to be gained by minimizing the misalignment between the top saws top and bottom saws on a double arbor gang saw machine. This misalignment is due to deflection of the saw blades and is a function of the depth of material through which the saw must cut. Since the minimum saw deflection is achieved when the saws are at the minimum cutting depth, it follows that the ideal position (in elevation) for the cant is to be centered between the top and bottom arbors (if the cant is too thick to be cut through be the saws on one arbor alone). The misalignment of the top and bottom saws causes a visual defect in the resulting product that can result in a decrease in sales price. Some operations intentionally space the saws in the gang father apart so that these defects can be removed later in a planing operation; the resulting loss in efficiency can be considerable. In other arrangements, workers have attempted to vary the heights of the conveying mechanism relative to a cutting device. While this would normally readily accomplish adjustment for different thicknesses of the workpieces, movement of the conveying apparatus is essentially impractical and not cost-effective on this type of machine. Another alternative would be sorting by thickness and then dispatching them to gang sawing devices that have the optimum configuration for each thickness. With the increasing cost of labor, capital and demands for production efficiency, this sorting technique which is time-consuming also becomes undesirable from a cost standpoint.

### SUMMARY OF THE INVENTION

The present invention addresses the problem of variations in the raw wood product in terms of thickness in a highly cost-effective manner and one which requires only a modest variation in the standard cutting mill machinery. The present invention provides a mechanism for moving the saw box vertically in its entirety relative to the transport conveyor or belt in advance of the individual cant which has been scanned upstream of the saw box so as to position the cutting edges of the individual gang saws as close to the ideal position as possible for the given dimensions of the incoming cant. Typically, in a mill operation, the variation in the vertical thickness of the cants as they are fed to the gang saw box may be on the order of 8 inches. While, in some operations, this range may be extended, the following description will assume this range for a standard mill operation. The normal configuration (in present operations) for a double arbor gang saw capable of cutting a 12″ thick cant is for the saws on each arbor to cut to a maximum depth of 6″. Because the elevation of the incoming cants in constant, this results in the bottom arbor cutting all the way through 4″ thick and 6″ thick cants. A 12″ cant is cut to a depth of 6″ by the bottom saw and 6″ by the top saws, which is the optimum in order to minimize saw deflection. On an 8″ thick cant, however, the bottom saw cuts to a depth of 6″ and the top to a depth of only 2″. A 10″ thick cant is cut to a depth of 6″ by the bottom saws but only 4″ by the top saws.

The present invention provides a mechanism for the saw box to allow repositioning rapidly to minimize saw deflection in operation of the saw. The sensing measurement will occur upstream of the saw box to allow quick adjustment.

### BRIEF DESCRIPTION OF THE DRAWINGS

The foregoing advantages of the present invention will become apparent as consideration is given to the following detailed description taken in conjunction with the accompanying drawings, in which:

FIG. 1 is an isometric view, partly in section, of a gang saw box such as disclosed in prior U.S. Pat. No. 5,722,474;

FIG. 2 is an enlarged view of two parallel extending rotatable arbors each carrying a plurality of blades, with only the end face of an end blade being visible, for cutting a cant which is shown positioned upstream of the blades;

FIG. 3 is a view similar to that a FIG. 2 but showing a different sized cant about to be fed between the teeth of the ganged saw blades;

FIG. 4 is a schematic view showing the saw box of the present invention mounted over a conveyor carrying a cant to the saw blades of the gang carried in the saw box and with a positioning mechanism carried on the platform which carries the saw box;

FIG. 5 is a detailed view of one of the mounting fingers of the saw box of the present invention inserted into a recess provided on the lower edge of the saw box;

FIGS. 6 and 7 are view similar to FIG. 4 but showing the interaction of the positioning mechanism in different positions; and

FIGS. 8A, 8B and 8C are end views of different sized cants entering the appropriately positioned gang saws.

### DETAILED DESCRIPTION OF THE INVENTION

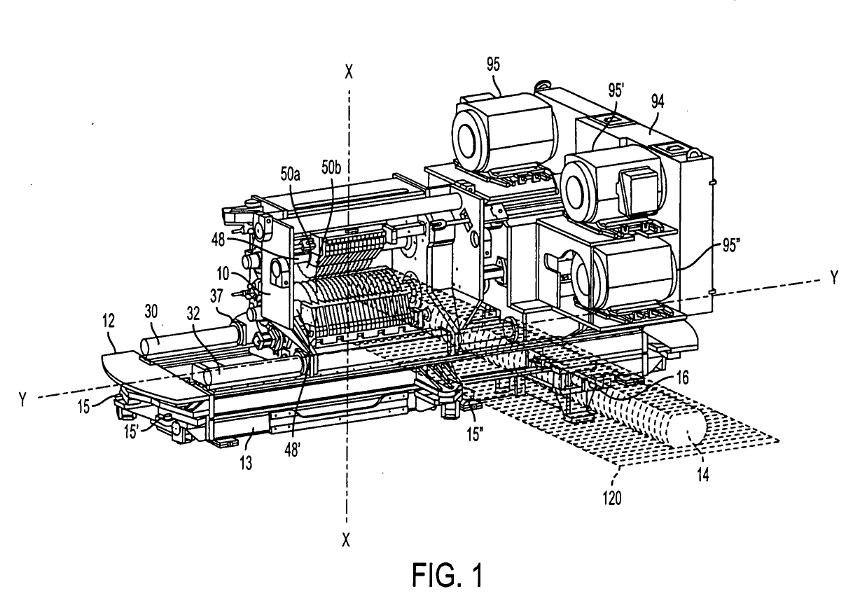

Referring to FIG. 1, there is shown a saw box 10 which typically will be mounted at its lower end such as to slide parallel to a horizontal axis Y on a pair of machined ways or rods 30 and 32 affixed to platform 12. Platform 12 is in turn supported and constrained by a system of wheels or rollers 15, 15′, 15″ and other obscured wheels or rollers located on fixed platform 13 to allow pivoting of the box 10 about a vertical axis X so that the generally parallel arbors or shafts 48 and 48′ can be positioned to accommodate curvature in an incoming board shown in broken lines at 14. This structure has enjoyed commercial success in this industry chiefly due to its accuracy in cutting usable boards from even severely curved cants. Typically, electric motors 95, 95′, 95″ (and other obscured motors) and drive belts (obscured inside guard 94) are employed in to rotate the ganged saw blades 50 A and 50 B. The saw blades are securely mounted in spaced arrangements along each arbor 48, 48′. Other arrangements are, of course, possible. The arbors 48, 48′ are fixedly mounted for rotation in the saw box preferably by suitable bearings provided in the sidewalls of the box 10. As described in the aforementioned patent, the saw box 10 can slide on ways or rods 30, 32 horizontally parallel to axis Y such as by an obscured hydraulic piston. The saw box, the slide ways or rods 30, 32 and the platform 12 are pivotable about a vertical axis X such as by hydraulic piston 16 connected to a portion of the platform 12 to allow the mill operator to handle a greater variation in curvatures in cants that can be usefully cut.

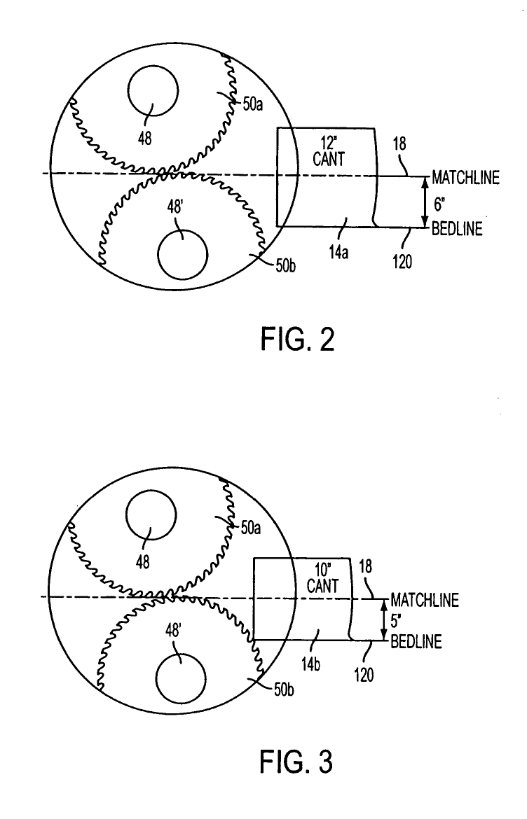

The present invention will extend the versatility of the machinery described in the aforementioned U.S. patent by allowing a mill operator to accurately cut cants of differing thickness and will also facilitate automatic adjustment of the elevation of the saw box relative to the conveying bed schematically indicated at 120 in FIG. 1 which feeds the cants 14 into and through the saw box 10. As shown in FIGS. 2 and 3, by way of example, two differently dimensioned cants 14 A and 14 B can be fed to the ganged saw blades 50 A and 50 B with the depth of the cuts of the saw blades 50 A and 50 B matched to the centerline 18 of each cant despite their different thicknesses. As shown, the cant 14 A has a thickness of 12 inches while cant 14 B has a thickness of 10 inches as measured vertically from the bed line conveyor 120. Also, it frequently happens that the blades themselves of the gang mounted on an arbor will deflect during use and while this cannot be avoided, the present invention will minimize any subsequent costs required to eliminate or compensate for defects resulting from such deflections.

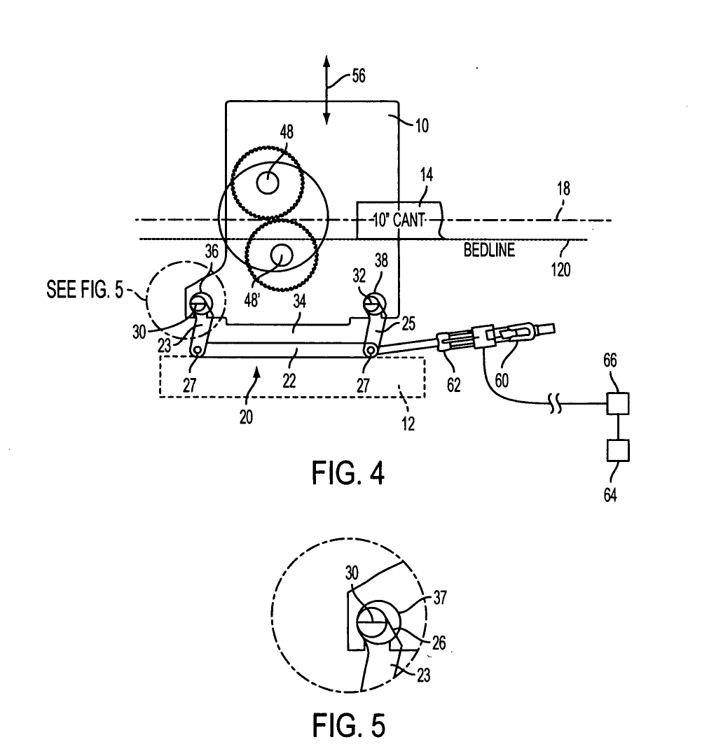

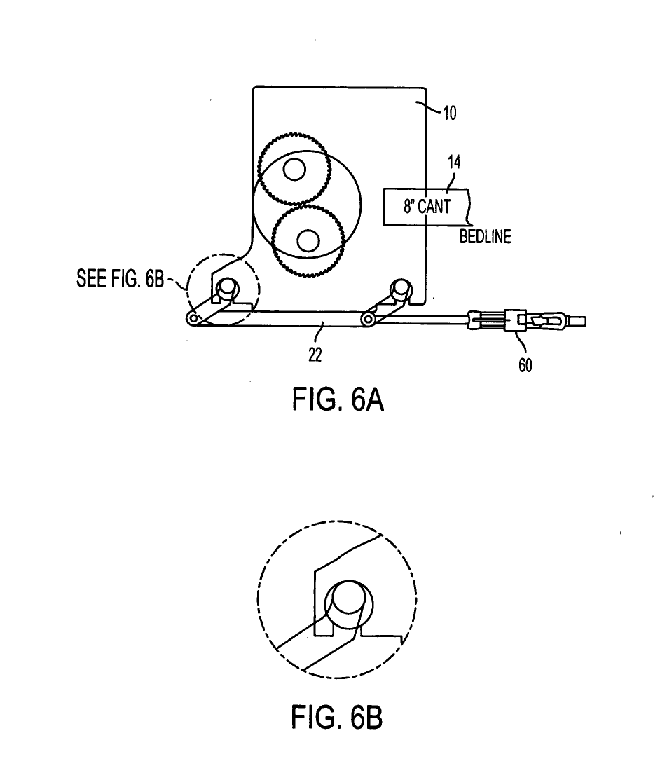

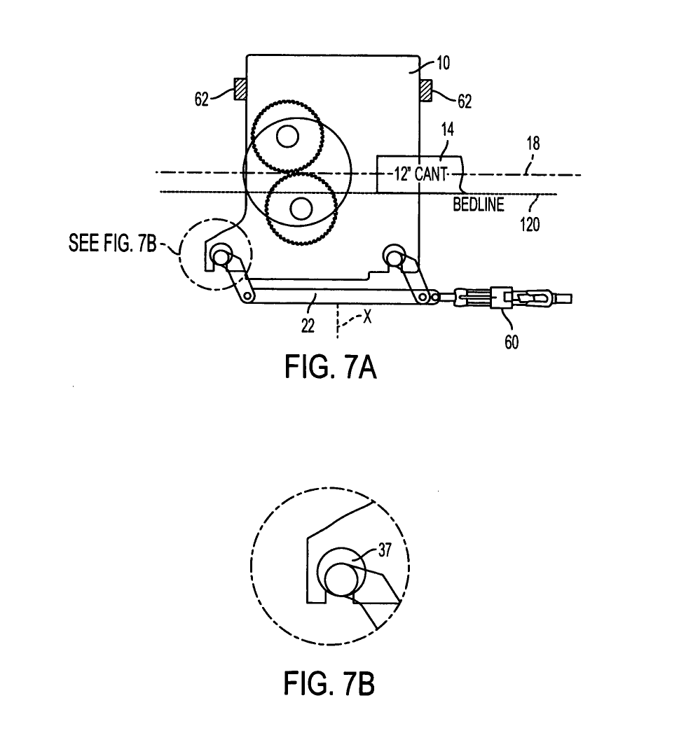

Referring to FIGS. 4 and 5, the present invention provides a positioning mechanism generally designated at 20 which is supported on the upper face of the pivoting platform 12. The positioning mechanism 20 includes a linkage arm 22 which will be mounted on the upper face of the platform 12 and includes four crank arms, only two of which are shown, including a forward crank arm 23 and a rear crank arm 25 on opposite sides of the linkage arm 22. The lower ends of each of the four crank arms 23 and 25 are pivotally mounted on the ends of the linkage arm 22 such as by pins 27. The upper ends 26 of each of the crank arms 23, 25 are attached rigidly to a machined way or rod indicated at 30 for the forward crank arms 23 and 32 for the rear pair of crank arms 25. The saw box along its bottom edge 34 is provided with downwardly opening recesses 36 at the forward side of the box 10 and 38 adjacent the rear face of the box 10. Each recess includes a bearing ring 37 to retain the respective rod 30 in its respective recess 36. It will be understood that the rods 30 and 32 extend across the width of the box 10 to the opposite side to register with corresponding aligned recesses provided on the opposite side of the box 10 from that shown in FIG. 4. To achieve movement, preferably a hydraulic cylinder and piston 60 is employed with the piston connected by a rod 60 to the linkage arm 22. The actuation of the piston 60 will be controlled by a computer and which will operate a valve box 66. The computer will be connected to sensors which will detect the vertical height of the cant passing at a point upstream of the saw box 10. A number of suitable sensors mechanisms are available on the market for this purpose. The piston 60 will then be fed with fluid to move the linkage arm 22 either leftward to lower the saw box 10 in the direction of arrows 56 to the position shown in FIG. 6 or rightward to move the saw box 10 to the position shown in FIG. 7. It will be understood from FIG. 1, that the saw box 10 includes the drive motors 95, 95′, guard 95 and associated housing.

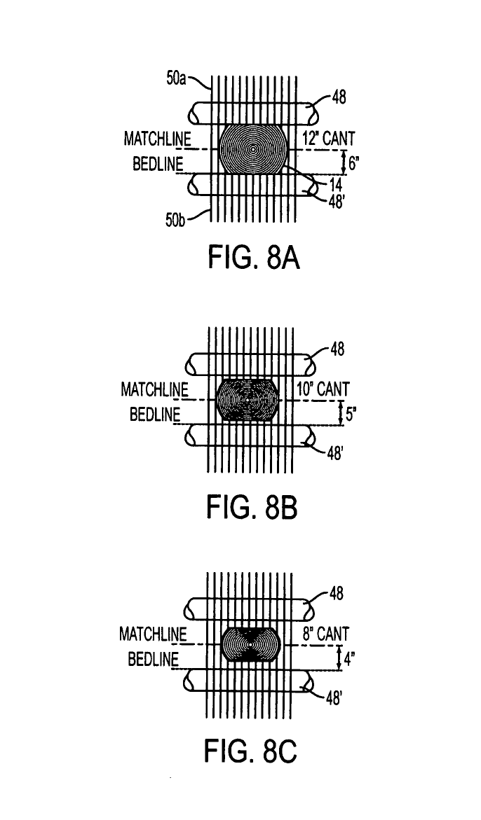

With the foregoing arrangement, the saw box of the present invention will be able to accommodate a wide range of wood cants such as those represented in FIGS. 8 A., 8 B and 8C. The mounting and suggested spacing of the saw blades 50 A and 50 B are also shown in these views.

What is claimed is:

1. A gang saw box having a pair of gangs of circular saws for cutting a cant into boards where a feed conveyor passes a cant along a feed axis with the saws of each gang mounted on a shaft rotatably carried by the saw box in spaced apart relation and relative to the feed axis with the shafts of each gang extending parallel to one another, sensing means for detecting the thickness of the cant at a point upstream of the saw box, a level adjustment device for moving the saw box relative to the feed axis so that the cant will be passed to the pair of gangs at a selected position relative to the feed axis.

2. The invention as claimed in claim 1 wherein the feed axis extends in a direction and said shaft of each gang extends transverse to said direction.

3. The invention as claimed in claim 1 wherein each cant has a mid point extending longitudinally thereof and the level adjustment device includes control means for maintaining the mid point of each cant at a selected distance from the feed axis

4. The invention as claimed in claim 3 wherein the selected distance is with the feed axis passing through the mid point of the cant.

5. The invention as claimed in claim 1 wherein the saw box has a bottom portion including bearing members, said level adjustment device includes elements engaged in said bearing members, said elements having the same length and opposite ends with one end respectively engaged in a said bearing member and the opposite end pivotally attached to a base whereby movement of said base relative to said saw box will vary the position of said pair of gangs relative to the feed axis.

6. The invention as claimed in claim 5 wherein the movement of pair of gangs is along a vertical axis.

7. The invention as claimed in claim 5 wherein a plurality of said elements is provided with pairs of said opposite ends connected by a linking arm so that movement of said linking arm will effect movement of said elements together.

8. The invention as claimed in claim 5 wherein said sawbox has opposite sides and two pairs of said elements are provided with one pair on one side of said sawbox and the other pair on the opposite side of said sawbox.

9. A method of operating a gang sawbox of for cutting cants into boards, where the sawbox is mounted for movement along a vertical axis and a conveyor feeds cants sequentially to the sawbox along a feed axis that extends substantially perpendicular to said vertical axis, comprising the steps of
a) detecting upstream of the sawbox the thickness of each cant and
b) adjusting the position of the sawbox relative to the feed axis so that the center line of each cant is substantially coextensive with said feed axis while the cutting operation is carried out.
